(19) United States
(12) Patent Application Publication
(10) Pub. No.: US 2024/0037656 A1
(43) Pub. Date: Feb. 1, 2024

(54) MARKET PRICE TRACKING FOR CRYPTO ASSETS

(71) Applicant: Lukka, Inc., Naples, FL (US)

(72) Inventors: Nick B. Ogurtsov, Houston, TX (US); Jillian Weakland, New York, NY (US); Allison Hupalo, New York, NY (US); Robert Materazzi, McLean, VA (US); Kinga Bosse, Naples, FL (US); Suzanne Morsfield, London (GB); Brandon Sang, Dallas, TX (US)

(21) Appl. No.: 17/876,291

(22) Filed: Jul. 28, 2022

(51) Int. Cl. G06Q 40/04

(52) U.S. Cl. CPC G06Q 40/04

(57) ABSTRACT

Systems and methods for market price tracking for crypto assets. An example method comprises: identifying, by a computing system, a plurality of crypto asset trading transaction records associated with one or more specified crypto asset trading accounts, wherein each crypto asset trading transaction record of the plurality of crypto asset trading transaction records represents one of: a crypto asset acquisition transaction with respect to a specified crypto asset or a crypto asset disposal transaction with respect to the specified crypto asset; matching one or more crypto asset disposal transactions of a plurality of crypto asset trading transactions reflected by the plurality of crypto asset trading transaction records to one or more crypto asset acquisition transactions of the plurality of crypto asset trading transactions; identifying an open crypto asset lot represented by one or more unmatched crypto asset acquisition transactions of the plurality of crypto asset trading transactions; responsive to determining that an acquisition price of the open crypto asset lot differs from an end-of-period price of the specified crypto asset, generating a simulated disposal transaction record closing the open crypto asset lot and a simulated acquisition transaction record creating a new open crypto asset lot associated with the specified crypto asset; and appending the simulated disposal transaction record and the simulated acquisition transaction record to the plurality of crypto asset trading transaction records.

### TECHNICAL FIELD

The present disclosure is generally related to computing systems, and is specifically related to methods and systems for market price-aware gain and loss computation for crypto asset transactions.

### BACKGROUND

Crypto assets are digital assets that use cryptographic techniques to generate a medium to be exchanged in public and/or private exchanges and to validate exchange transactions. Examples of digital assets include cryptocurrencies, utility coins, and security tokens. Certain transactions in crypto assets may represent taxable events, as defined by pertinent laws.

### BRIEF DESCRIPTION OF THE DRAWINGS

The present disclosure is illustrated by way of examples, and not by way of limitation, and may be more fully understood with references to the following detailed description when considered in connection with the figures, in which:

FIG. 1 schematically illustrates an example workflow 100 of computing gain and loss for crypto asset transactions while tracking the crypto asset market price by a computing system operating in accordance with aspects of the present disclosure.

FIG. 2 schematically illustrates an example data structure for storing normalized transaction records in accordance with one or more aspects of the present disclosure.

FIG. 3 schematically illustrates the market price tracking operation of the example workflow of computing gain and loss by a computing system operating in accordance with aspects of the present disclosure.

FIG. 4 schematically illustrates computing a gain or a loss associated with a set of crypto asset transaction records by a computing system operating in accordance with aspects of the present disclosure.

FIG. 5 depicts a flow diagram of an example method 400 of computing gain and loss for crypto asset transactions while tracking the crypto asset market price, in accordance with one or more aspects of the present disclosure.

FIG. 6 schematically illustrates a component diagram of an example wireless lighting control network node operating in accordance with one or more aspects of the present disclosure.

### DETAILED DESCRIPTION

Described herein are systems and methods market price tracking for crypto assets.

Certain transactions in crypto asset, such as crypto asset disposals, may represent taxable events. While taxation rules are usually jurisdiction-dependent, a crypto asset disposal transaction may entail realization of a gain or a loss, which generally represents a taxable event in various jurisdictions.

The market price of a given crypto asset may fluctuate (increase or decrease) over time. Reduction in the market price of a crypto asset may be characterized as impairment of the crypto asset, while increase in the market price may be characterized as appreciation of the crypto asset. Pursuant to pertinent laws and regulations, certain fluctuations in the market price of a crypto asset may need to be reflected in the balance sheet. In an illustrative example, only crypto asset impairment at the end of each accounting period may be reflected in the balance sheet. In another illustrative example, both impairment and appreciation of the crypto asset (“mark to market”) at the end of each accounting period may be reflected in the balance sheet.

The systems and methods of the present disclosure facilitate tracking the market price of a particular crypto asset by generating simulated transaction records reflecting certain movements of the crypto asset market price. The generated simulated transaction records may be combined with the legacy transaction records (i.e., transaction records reflecting acquisition and/or disposal transactions) in order to compute a gain or a loss associated with the crypto asset.

In some implementations, the computing system executing the systems and methods described herein may continuously or periodically receive transaction records related to crypto asset trades and transfers performed by a specified person (e.g., a natural person or a corporation) or a group of affiliated persons via one or more crypto asset accounts maintained at one or more crypto asset trading platforms. The computing system may translate the received raw transaction records into a set of normalized transaction records conforming to a predetermined format optimized for subsequent processing.

The computing system may periodically process the normalized transaction records in order to compute the gain and/or loss resulting from the transactions reflected by the normalized transaction records. In an illustrative example, one or more acquisition transactions would be matched to each disposal transaction; the matched acquisition transactions may include at least one partially matched transaction. For each disposal transaction and the matched acquisition transactions, the resulting gain or loss may be computed.

Furthermore, the computing system may, at the end of each accounting period, apply the market price tracking logic to open crypto asset lots represented by unmatched acquisition transactions.

For each open crypto asset lot, the computing system may compare its acquisition price to the end-of-period price of the acquired crypto asset (i.e., the price at the end of a specified accounting period, e.g., the current accounting period or a past accounting period). Should the end-of-period price differ from the acquisition price of an open crypto asset lot, the computing system may apply the market price tracking logic to the open crypto asset lot by creating two simulated transaction records. The first simulated transaction record would reflect a simulated disposal transaction (e.g., an impairment disposal transaction reflecting the end-of-period market price falling below the acquisition price or an appreciation disposal transaction reflecting the end-of-period market price exceeding the acquisition price) closing the open crypto asset lot using the disposal price equal to the end-of-period price of the crypto asset. The second simulated transaction record would reflect a simulated acquisition transaction (e.g., an impairment acquisition transaction reflecting the end-of-period market price falling below the acquisition price or an appreciation acquisition transaction reflecting the end-of-period market price exceeding the acquisition price) creating a new open crypto asset lot for the same crypto asset with the acquisition price equal to the end-of-period price.

The closed crypto asset lot(s) are removed from the set of transaction records. Conversely, the newly created open crypto asset lot(s) will participate in the gain and loss computation at the end of the next accounting period, as explained in more detail hereinbelow.

Thus, the present disclosure provides efficient methods of market price tracking for crypto asset transactions, which are described in more detail hereinbelow. The systems and methods described may be implemented by hardware (e.g., general purpose and/or specialized processing devices, and/or other devices and associated circuitry), software (e.g., instructions executable by a processing device), or a combination thereof. In an illustrative example, a computing system implementing the systems and methods of the present disclosure may be provided by one or more virtual or physical execution environments (e.g., virtual or physical servers).

Various aspects of the above referenced methods and systems are described in detail hereinbelow by way of examples, rather than by way of limitation.

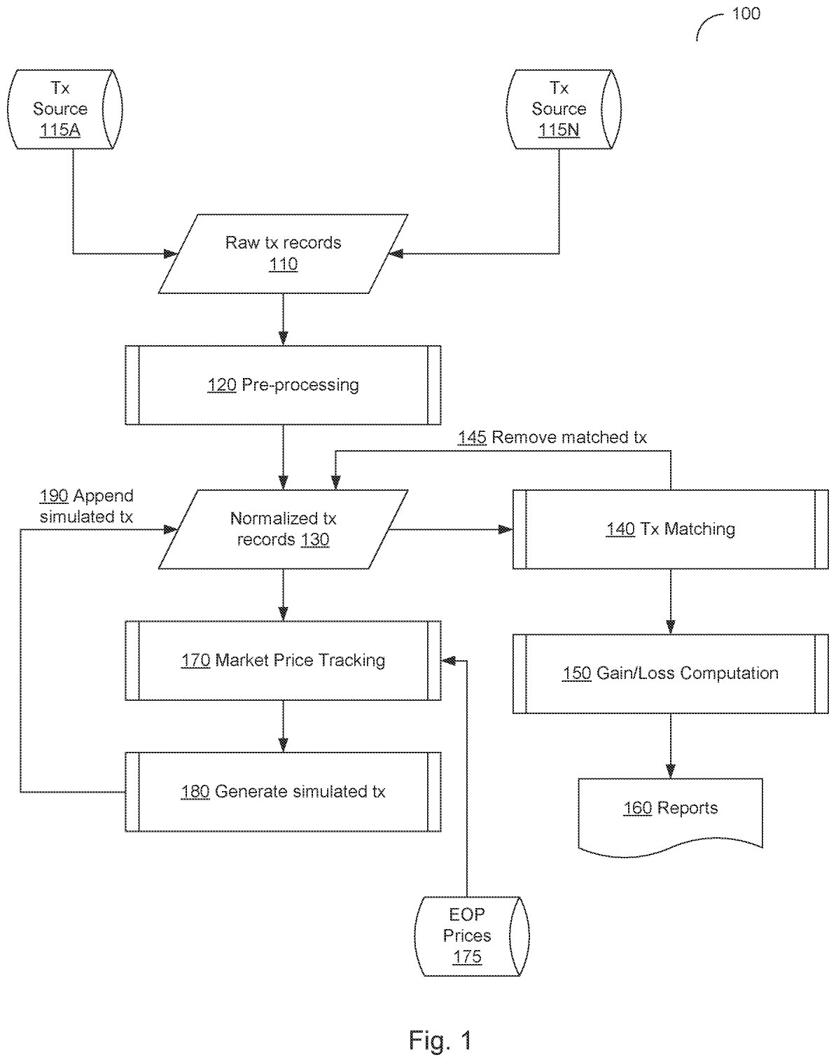

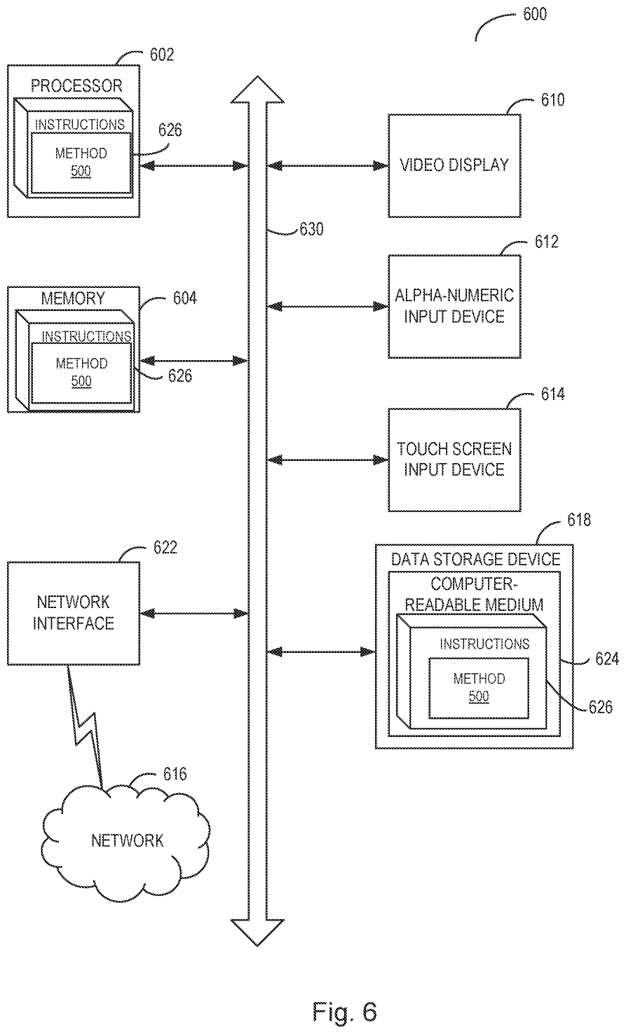

FIG. 1 schematically illustrates an example workflow 100 of computing gain and loss for crypto asset transactions while tracking the crypto asset market price by a computing system operating in accordance with aspects of the present disclosure. Workflow 100 and each of its individual functions, routines, subroutines, or operations may be implemented by one or more software modules running in one or more virtual or physical execution environments (e.g., virtual or physical servers) or collocated with other servers or applications. In an illustrative example, workflow 100 may be implemented by the example computing system 600 of FIG. 6.

As schematically illustrated by FIG. 1, the computing system implementing the workflow 100 may continuously or periodically receive batches of raw transaction records 110 related to crypto asset trades and transfers performed by a specified person (e.g., a natural person or a corporation) or a group of affiliated persons via one or more crypto asset accounts maintained at one or more crypto asset trading platforms. In some implementations, raw transaction records may be received, e.g., from one or more raw transaction sources 115A-115N including for example, crypto asset trading platforms and customer accounting platforms.

The computing system may then pre-process (operation 120) the raw transaction records 110, which may come in various formats. By parsing raw transaction records, the computing system may extract the transaction amount(s), the transaction currency(-ies), the timestamp, and/or various other information. Based on the extracted information, the computing system may determine the transaction type associated with the raw transaction record being analyzed. In various illustrative examples, the transaction types may include, acquisition transactions, disposal transactions, deposit transactions, withdrawal transactions, fee payment transactions, etc.

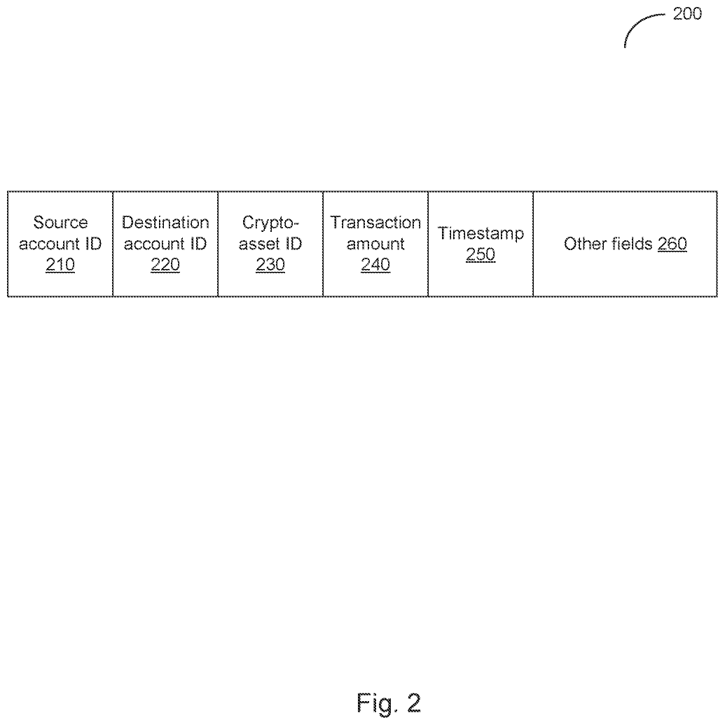

The computing system may translate the raw transaction records 110 into a set of normalized transaction records 130 conforming to a specified format. In some implementations, a separate set of normalized transaction records is maintained for each crypto asset. Each normalized transaction record 130 may reflect a transfer of a specified amount of a specified asset from a source account to a destination account, which was recorded at the time identified by the transaction timestamp. As schematically illustrated by FIG. 2, each normalized transaction record 200 may include the source account identifier 210, the destination account identifier 220, the crypto asset identifier 230, the transaction amount 240, and a timestamp 250. The transaction amount 240 may be represented by a positive value of an acquisition transaction or a negative value for a disposal transaction. The transaction record 200 may include various other fields 260, such as one or more sub-account identifiers and/or other transaction attributes.

In an illustrative example, translating the raw transaction records 110 into normalized transaction records 130 may further involve validating and normalizing asset identifiers (e.g., by comparing an asset identifier specified by a transaction record to a dictionary of asset identifiers). In another illustrative example, translating the raw transaction records 110 into normalized transaction records 130 may further involve validating and/or modifying various other transaction record fields (e.g., assigning a sub-account identifier by applying a rule processing one or more transaction attributes specified by certain transaction record fields). In another illustrative example, translating the raw transaction records 110 into normalized transaction records 130 may further involve filtering the raw transaction records 110, by discarding the raw transaction records 110 that fail to satisfy one or more filtering conditions that may be defined based on one or more transaction attributes specified by certain transaction record fields.

In some implementations, the computing system may assign each transaction record to one or more accounting perimeters (formed by accounts, sub-accounts, and/or other transaction attributes), such that only perimeter-crossing transactions will be considered for the purposes of gain and loss computation. In the simplest example, all customer's accounts may be considered as forming a single accounting perimeter, and thus any transaction transferring an asset between two customer's accounts will not be considered as a perimeter-crossing transaction, and will therefore be excluded from the gain and loss computation. In various other illustrative examples, the customer may define multiple accounting perimeters based on sub-accounts and/or other transaction attributes, such that the accounting perimeters may be at least partially intersecting and/or nested.

The resulting normalized set(s) of transaction records 130 associated with a specified crypto asset may be stored in volatile and/or non-volatile memory. In some implementations, a set of the normalized transaction records 130 may be stored in a data structure that preserves a chronological order of their respective timestamps, such as a queue or a linked list, each element of which includes at least a subset of the fields of the example transaction record 200 of FIG. 2. In some implementations, the normalized transaction records may be stored in multiple data structures corresponding to the transaction types, such as, one data structure (e.g., a queue or a linked list) storing acquisition transactions and another data structure (e.g., a queue or a linked list) storing disposal transactions.

The operations of receiving and translating raw transaction records 110 into normalized transaction records 130 may be performed continuously or periodically, such that new batches of raw transaction records may be appended to the set of raw transaction records 110 asynchronously with respect to other operations of the workflow 100. The new batches of raw transaction records 110 may be translated into normalized transaction records 130 asynchronously with respect to other operations of the workflow 100.

The computing system may periodically (e.g., at the end of each accounting period) process (operation 140) the normalized transaction records 130 in order to match disposal and acquisition transactions. The accounting period may be specified by a configurable parameter of the computing system.

In an illustrative example, one or more acquisition transactions may be matched to each disposal transaction; the matched acquisition transactions may include at least one partially matched transaction. In an illustrative example, for a given crypto asset disposal transaction, one or more crypto asset acquisition transactions are identified that satisfy the following conditions: (a) the identified crypto asset acquisition transactions are performed with respect to the same crypto asset as the crypto asset traded by the given crypto asset disposal transaction; (b) the timestamps of the identified crypto asset acquisition transactions precede the timestamp of the given crypto asset disposal transaction; and (c) the total amount of the identified crypto asset disposal transactions matches the amount of the given crypto asset disposal transaction (the matched crypto asset acquisition transactions may include at least one partially matched crypto asset transaction, i.e., only a part of the amount of the crypto asset acquisition transaction may be matched to the given crypto asset disposal transaction).

The matched sets of disposal and acquisition transactions, which may be referred to as “closed crypto asset lots”, may be removed (operation 145) from the data structure(s) storing the normalized crypto asset transaction records 130. The unmatched crypto asset acquisition transactions may be referred to as “open crypto asset lots.” In an illustrative example, each unmatched crypto asset acquisition transaction represents an open crypto asset lot. In another illustrative example, two or more unmatched crypto asset acquisition transactions performed with respect to the same crypto asset on the same date may be grouped to form a single open crypto asset lot. The open crypto asset lots may be further processed by the crypto asset price tracking logic, as described in more detail hereinbelow.

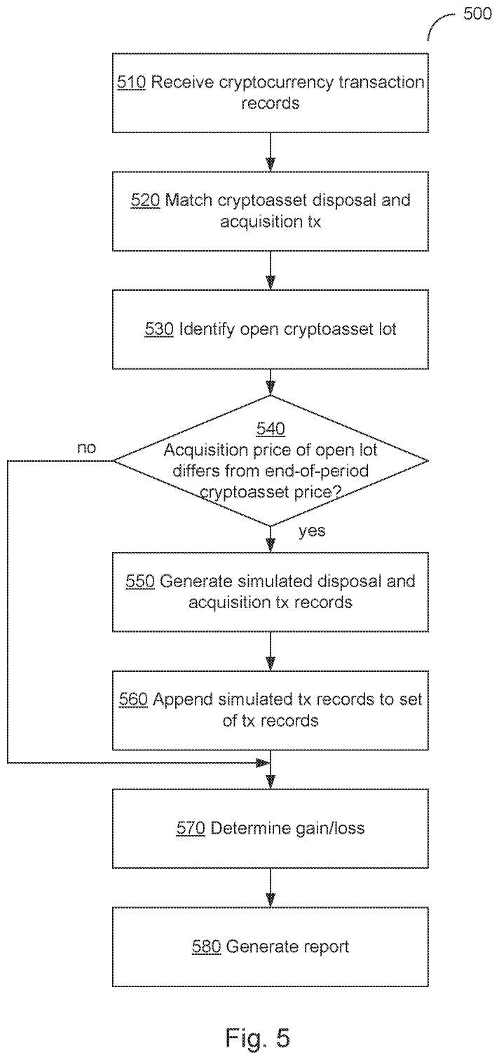

For each disposal transaction and the matched acquisition transactions, the resulting gain or loss may be computed (operation 150). In an illustrative example, the gain/loss computation may involve determining, for each of the matched disposal and acquisition transactions, the transaction amount in a chosen fiat currency (e.g., U.S. dollars) based on the historic price of the crypto asset which has been acquired or disposed by the transaction. “Historic price” herein shall refer to the price which was effective at the time of performing the corresponding disposal or acquisition transaction. Upon determining the historic price-based transaction amounts in the chosen fiat currency, the computing system may compute, for each disposal transaction and the matched acquisition transactions, the resulting gain or loss, by summing up the fiat currency amount of the disposal transaction and the fiat currency amounts of the matched acquisition transactions, such that a positive result would indicate a gain while a negative result would indicate a loss (assuming that the disposal transaction amount is positive, while acquisition transaction amounts are negative), as described in more detail hereinbelow with reference to FIG. 5. The computed gains or losses for the matched transactions, as well as other relevant data, may be summarized in one or more reports 160 in various fixed or user-defined formats.

As noted hereinabove, the computing system implementing the workflow 100 may, at the end of each accounting period, track (operation 170) the market prices of the crypto assets referenced by the transaction records 130. In some implementations, the computing system may periodically receive, from one or more sources, end-of-period prices 175 for the crypto assets referenced by the transaction records that are being processed by the workflow 100.

In an illustrative example, only crypto asset impairment at the end of each accounting period may be tracked by the computing system. In another illustrative example, both impairment and appreciation of the crypto asset (“mark to market”) at the end of each accounting period may be tracked by the computing system. The type of market price tracking may be specified by one or more configurable parameters of the computing system (e.g., each of impairment tracking and appreciation tracking may be specified by a respective Boolean parameter; alternatively, a single Boolean parameter may specify either impairment tracking or “mark to market” tracking).

In some implementations, the computing system may, at the end of each accounting period, generate (operation 180), for each open crypto asset lot, simulated transaction records reflecting certain movements of the crypto asset market price.

In an illustrative example, the computing system may traverse the open crypto asset lots and, for each open crypto asset lot, compare the crypto asset lot acquisition price with the end-of-period price of the crypto asset acquired by the open crypto asset lot. Should the two prices be different (or, in some implementations, differ by at least a predefined threshold value), the computing system may generate a simulated disposal transaction record closing the open crypto asset lot and a simulated acquisition transaction record creating a new open crypto asset lot associated with the crypto asset.

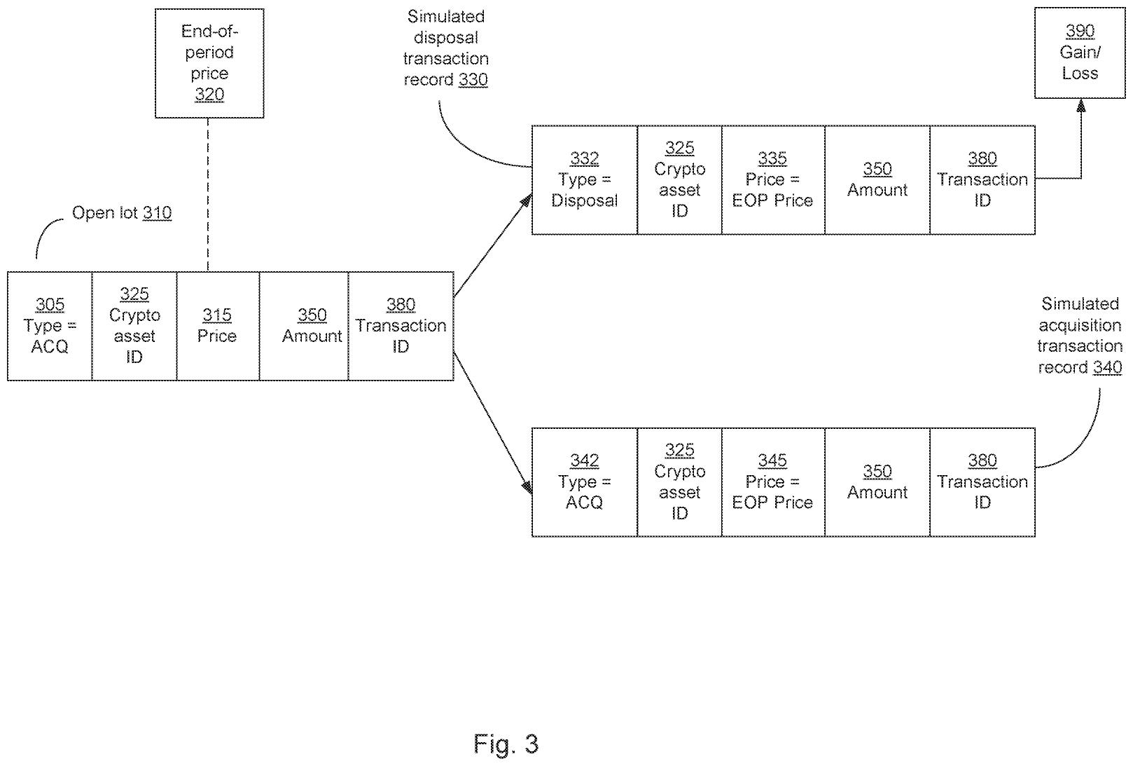

The simulated disposal transaction record closes the open crypto asset lot at the disposal price that is equal to the end-of-period price of the crypto asset. Conversely, the simulated acquisition transaction record creates a new open crypto asset lot at the acquisition price that is equal to the end-of-period price of the crypto asset, as described in more detail hereinbelow with reference to FIG. 3.

If the acquisition price of the open crypto asset lot exceeds the end-of-period price of the crypto asset acquired by the open crypto asset lot, the simulated disposal transaction record and the simulated acquisition transaction record would reflect impairment of the crypto asset. Conversely, if the acquisition price of the open crypto asset lot is less than the end-of-period price of a crypto asset acquired by the open crypto asset lot, the simulated disposal transaction record and the simulated acquisition transaction record would reflect appreciation of the crypto asset. As noted hereinabove, in some implementations only crypto asset impairment at the end of each accounting period may be tracked by the computing system. Alternatively, both impairment and appreciation of the crypto asset (“mark to market”) at the end of each accounting period may be tracked by the computing system.

The generated simulated transaction records may be appended (operation 190) to the set of normalized transaction records 130 in order to compute a gain or a loss associated with the crypto asset at the end of the subsequent accounting period.

As noted herein above, the computed gains or losses for the matched transactions, as well as other relevant data, may be summarized in one or more reports 160 in various fixed or user-defined formats. The reports may be visually rendered via a graphical user interface (GUI), saved to one or more files, and/or printed. In an illustrative example, the reports may be formatted for rendering via a GUI of a portable computing device (such as a smartphone or a tablet).

In certain implementations, the computing system implementing the methods described herein may utilize the computed gain or losses, as well as other relevant data, for producing one or more electronic tax accounting forms, which may be reviewed and electronically signed by the user. Upon obtaining the user's electronic signature, the computing system may upload the electronic tax accounting forms to a server of a government agency that is authorized to accept electronic tax form filings.

FIG. 3 schematically illustrates the market price tracking and simulated transaction generation operations 170-180 of example workflow 100 of FIG. 1 implemented by a computing system operating in accordance with aspects of the present disclosure. As schematically illustrated by FIG. 3, the computing system may traverse the open crypto asset lots and, for each open crypto asset lot (represented by a corresponding crypto asset acquisition transaction 310 having the “acquisition” transaction type 305) compare the acquisition price 315 of the transaction 310 with the end-of-period price 320 of the crypto asset acquired by the crypto asset acquisition transaction 310. Should the two prices be different (or, in some implementations, differ by at least a predefined threshold value), the computing system may generate a simulated disposal transaction record 330 (having the “disposal” transaction type 332) and a simulated acquisition transaction record 340 (having the “acquisition” transaction type 342). The threshold price difference that would trigger creation of the simulated transaction records may be specified by a configurable parameter of the computing system implementing the workflow 100.

The simulated disposal transaction record 330 closes the open crypto asset lot represented by the crypto asset acquisition transaction 310 at the disposal price 335 that is equal to the end-of-period price of the crypto asset identified by the crypto asset identifier 325; the amount 350 of the simulated disposal transaction 330 matches the amount 350 of the open lot represented by the crypto asset acquisition transaction 310.

The simulated acquisition transaction record 340 creates a new open crypto asset lot 350 at the acquisition price 345 that is equal to the end-of-period price of the crypto asset identified by the crypto asset identifier 325; the amount 350 of the newly open crypto asset lot matches the amount 350 of the crypto asset open lot represented by the original crypto asset acquisition transaction 310.

In some implementations, the newly generated simulated disposal transaction record 330 and simulated acquisition transaction record 340 may inherit the transaction identifier 380 of the original crypto asset acquisition transaction 310. Alternatively, the newly generated simulated disposal transaction record 330 and simulated acquisition transaction record 340 may be assigned new transaction identifiers.

As noted herein above, the newly generated simulated disposal transaction record 330 and simulated acquisition transaction record 340 may be appended to the set of normalized transaction records 130 in order to compute a gain or a loss 390 associated with the crypto asset at the end of the subsequent accounting period.

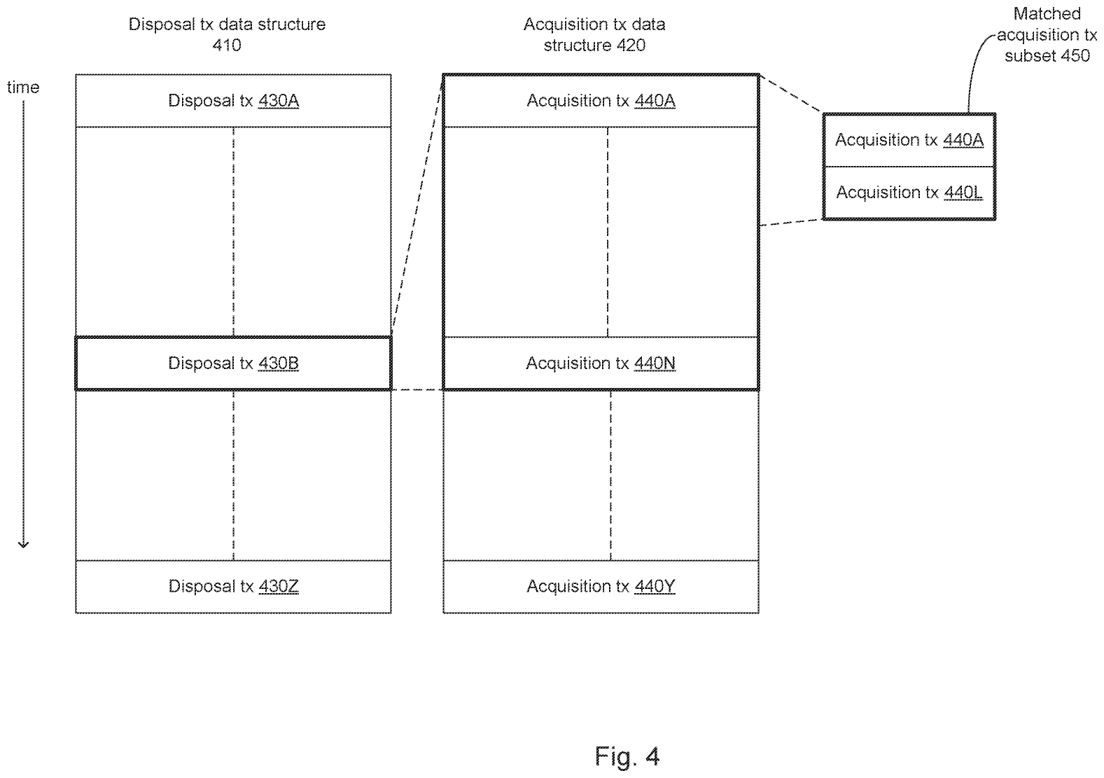

FIG. 4 schematically illustrates computing a gain or a loss associated with a set of crypto asset transaction records by a computing system operating in accordance with aspects of the present disclosure. As noted hereinabove, the computing system may periodically (e.g., at the end of each accounting period) process the normalized transaction records in order to match disposal and acquisition transactions.

As schematically illustrated by FIG. 4, the computing system may store, in multiple data structures corresponding to the transaction types, the normalized transaction records reflecting crypto asset trading transactions performed with respect to a specified crypto asset trading transactions performed by a specified person or a group of affiliated persons via one or more crypto asset accounts maintained at one or more crypto asset trading platforms. In an illustrative example, the crypto asset trading transaction records are stored in the disposal transaction data structure 410 (e.g., a queue or a linked list) storing disposal transaction records and the acquisition transaction data structure 420 (e.g., a queue or a linked list) storing acquisition transaction records. The data structures may preserve the chronological order of the transaction timestamps, i.e., the transaction data structures 410 and 420 may be sorted in the ascending order of transaction timestamps.

The computing system may traverse the disposal transaction data structure 410 starting from the least recent transactions, and for each disposal transaction record 430 (e.g., for disposal transaction 430B) may select a subset of acquisition transaction records 440A-440N from the acquisition transaction data structure 420, such that the timestamp of each identified acquisition transaction record 440A-440N is less than the timestamp of the currently selected disposal transaction record 430B. The acquisition transaction records 440A-440N may be considered as representing a candidate acquisition transaction for matching with the currently selected disposal transaction record 430B.

The computing system may then traverse the identified candidate acquisition transaction records 440A-440N in the chosen order (e.g., selecting the most recent acquisition transaction first for matching with a given disposal transaction (i.e., last in—first out (LIFO)) or selecting the least recent acquisition transaction first for matching with a given disposal transaction (i.e., first in—first out (FIFO)). The computing system may then identify one or more acquisitions transaction records 440A-440L such that their total amount would be equal to the amount of the currently selected disposal transaction record 430B. The matched crypto asset acquisition transactions may include at least one partially matched crypto asset transaction, i.e., only a part of the amount of the crypto asset acquisition transaction may be matched to the given crypto asset disposal transaction.

FIG. 5 depicts a flow diagram of an example method 500 computing gain and loss for crypto asset transactions while tracking the crypto asset market price, in accordance with one or more aspects of the present disclosure. Method 500 and/or each of its individual functions, routines, subroutines, or operations may be performed by one or more processors of a computing system (e.g., the example computing system 600 of FIG. 6) implementing the method. In certain implementations, method 500 may be performed by a single processing thread. Alternatively, method 500 may be performed by two or more processing threads, each thread executing one or more individual functions, routines, subroutines, or operations of the method. In an illustrative example, the processing threads implementing method 500 may be synchronized (e.g., using semaphores, critical sections, and/or other thread synchronization mechanisms). Alternatively, the processing threads implementing method 500 may be executed asynchronously with respect to each other.

As schematically illustrated by FIG. 5, at block 510, the computing system implementing the method identifies a set of crypto asset trading transaction records associated with one or more specified crypto asset trading accounts (i.e., transaction records in which the source account and/or the destination account is one of the specified crypto asset trading accounts). Each crypto asset trading transaction record represents a crypto asset acquisition transaction or a crypto asset disposal transaction with respect to a specified crypto asset. In some implementations, the computing system may continuously or periodically receive batches of raw transaction records reflecting crypto asset trades performed by a specified person or a group of affiliated persons via one or more crypto asset accounts maintained at one or more crypto asset trading platforms. The computing system may then translate the raw transaction records into normalized transaction records, as described in more detail herein above.

At block 520, the computing system matches one or more crypto asset disposal transactions of the crypto asset trading transactions reflected by the set of crypto asset trading transaction records to one or more crypto asset acquisition transactions of the plurality of crypto asset trading transactions. In some implementations, one or more acquisition transactions may be matched to each disposal transaction; the matched acquisition transactions may include at least one partially matched transaction, as described in hereinabove.

At block 530, the computing system identifies an open crypto asset lot represented by one or more unmatched crypto asset acquisition transactions. In an illustrative example, each unmatched crypto asset acquisition transaction represents an open crypto asset lot. In another illustrative example, an open lot may include at least one partially unmatched acquisition transaction, such that a part of the transaction amount has already been matched to a crypto asset disposal transaction. In yet another illustrative example, two or more unmatched crypto asset acquisition transactions performed with respect to the same crypto asset on the same date may be grouped to form a single open crypto asset lot, as described hereinabove.

Responsive to determining, at block 540, that an acquisition price of a crypto asset of the open crypto asset lot differs from an end-of-period price of the crypto asset of the open crypto asset lot, the computing system, at block 550, generates a simulated disposal transaction record and a simulated acquisition transaction record. The simulated disposal transaction record closes the open crypto asset lot at the disposal price that is equal to the end-of-period price of the crypto asset. Conversely, the simulated acquisition transaction record creates a new open crypto asset lot at the acquisition price that is equal to the end-of-period price of the crypto asset, as described hereinabove.

At block 560, the computing system appends the simulated disposal transaction record and the simulated acquisition transaction record to the plurality of crypto asset trading transaction records.

At block 570, the computing system determines gain and/or loss associated with the matched crypto asset disposal transactions. In an illustrative example, the computing system may determine, for each of the matched disposal and acquisition transactions, the transaction amount in a chosen fiat currency based on the historic price (i.e., the fiat currency price that was effective at the time identified by the transaction timestamps) of the crypto asset that has been acquired or disposed by the transaction. The computing system may then compute, for each disposal transaction and the matched acquisition transactions, the resulting gain or loss, by summing up the fiat currency amount of the disposal transaction and the fiat currency amounts of the matched acquisition transactions, as described hereinabove.

At block 580, the computing system generates a report reflecting the gain or loss associated with the matched crypto asset disposal transactions. In some implementations the computing system may generate one or more electronic tax accounting forms reflecting the computed gain or loss associated with the matched crypto asset disposal transactions. The report may then be reviewed and electronically signed by the user. Upon obtaining the user's electronic signature, the computing system may upload the electronic tax accounting forms to a server of a government agency that is authorized to accept electronic tax form filings.

FIG. 6 depicts a component diagram of an example computing system which may be employed for implementing the methods described herein. The computing system 600 may be connected to other computing systems in a LAN, an intranet, an extranet, or the Internet. The computing system 600 may operate in the capacity of a server or a client computing system in a client-server network environment, or as a peer computing system in a peer-to-peer (or distributed) network environment. The computing system 600 may be a provided by a personal computer (PC), a tablet PC, a set-top box (STB), a Personal Digital Assistant (PDA), a cellular telephone, or any computing system capable of executing a set of instructions (sequential or otherwise) that specify operations to be performed by that computing system. Further, while only a single computing system is illustrated, the term “computing system” shall also be taken to include any collection of computing systems that individually or jointly execute a set (or multiple sets) of instructions to perform any one or more of the methods described herein.

Exemplary computing system 600 includes a processor 602, a main memory 604 (e.g., read-only memory (ROM) or dynamic random access memory (DRAM)), and a data storage device 618, which communicate with each other via a bus 630.

Processor 602 may be represented by one or more general-purpose processing devices such as a microprocessor, central processing unit, or the like. More particularly, processor 602 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processor 602 may also be one or more special-purpose processing devices such as an application specific integrated circuit (ASIC), a field programmable gate array (FPGA), a digital signal processor (DSP), network processor, or the like. Processor 602 is configured to execute instructions 626 for performing the methods described herein.

Computing system 600 may further include a network interface device 622, a video display unit 610, a character input device 612 (e.g., a keyboard), and a touch screen input device 614.

Data storage device 616 may include a computer-readable storage medium 624 on which is stored one or more sets of instructions 626 embodying any one or more of the methods or functions described herein. Instructions 626 may also reside, completely or at least partially, within main memory 604 and/or within processor 602 during execution thereof by computing system 600, main memory 604 and processor 602 also constituting computer-readable storage media. Instructions 626 may further be transmitted or received over network 616 via network interface device 622.

In an illustrative example, instructions 626 may include instructions of method 500 implemented in accordance with one or more aspects of the present disclosure. While computer-readable storage medium 624 is shown in the example of FIG. 6 to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methods of the present disclosure. The term “computer-readable storage medium” shall accordingly be taken to include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and software components, or only in software.

In the foregoing description, numerous details are set forth. It will be apparent, however, to one of ordinary skills in the art having the benefit of this disclosure, that the present disclosure may be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, graphemes, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “determining”, “computing”, “calculating”, “obtaining”, “identifying,” “modifying” or the like, refer to the actions and processes of a computing system, or similar electronic computing system, that manipulates and transforms data represented as physical (e.g., electronic) quantities within the computing system's registers and memories into other data similarly represented as physical quantities within the computing system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

It is to be understood that the above description is intended to be illustrative, and not restrictive. Various other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method, comprising:
identifying, by a computing system, a plurality of crypto asset trading transaction records associated with one or more specified crypto asset trading accounts, wherein each crypto asset trading transaction record of the plurality of crypto asset trading transaction records represents one of: a crypto asset acquisition transaction with respect to a specified crypto asset or a crypto asset disposal transaction with respect to the specified crypto asset;
matching one or more crypto asset disposal transactions of a plurality of crypto asset trading transactions reflected by the plurality of crypto asset trading transaction records to one or more crypto asset acquisition transactions of the plurality of crypto asset trading transactions;
identifying an open crypto asset lot represented by one or more unmatched crypto asset acquisition transactions of the plurality of crypto asset trading transactions;
responsive to determining that an acquisition price of the open crypto asset lot differs from an end-of-period price of the specified crypto asset, generating a simulated disposal transaction record closing the open crypto asset lot and a simulated acquisition transaction record creating a new open crypto asset lot associated with the specified crypto asset; and
appending the simulated disposal transaction record and the simulated acquisition transaction record to the plurality of crypto asset trading transaction records.

2. The method of claim 1, wherein the simulated disposal transaction record reflects a disposal price of the specified crypto asset equal to the end-of-period price.

3. The method of claim 1, wherein the simulated acquisition transaction record reflects an acquisition price of the specified crypto asset equal to the end-of-period price.

4. The method of claim 1, wherein the acquisition price of the open crypto asset lot exceeds the end-of-period price of the specified crypto asset, and wherein the simulated disposal transaction record and the simulated acquisition transaction record reflect impairment of the crypto asset.

5. The method of claim 1, wherein the acquisition price of the open crypto asset lot is less than the end-of-period price of the specified crypto asset, and wherein the simulated disposal transaction record and the simulated acquisition transaction record reflect appreciation of the crypto asset.

6. The method of claim 1, wherein matching the one or more crypto asset disposal transactions to the one or more crypto asset acquisition transactions further comprises:
selecting a crypto asset disposal transaction of the plurality of crypto asset disposal transactions;
selecting, among the plurality of crypto asset acquisition transactions, one or more crypto asset acquisition transactions having a total amount equal to the amount of the selected crypto asset disposal transaction.

7. The method of claim 1, wherein identifying the plurality of crypto asset trading transaction records further comprises:
applying one or more perimeter definition rules to a set of normalized transaction records.

8. The method of claim 1, further comprising:
determining, for the matched crypto asset disposal transactions, one of: a gain associated with the matched crypto asset disposal transactions or a loss associated with the matched crypto asset disposal transactions.

9. The method of claim 8, wherein computing the gain is performed using respective fiat currency transaction amounts of the matched crypto asset disposal transactions, wherein each fiat currency transaction amount is based on a fiat currency price of the specified crypto asset at the respective crypto asset disposal transaction, wherein the fiat currency price was effective at a time identified by a timestamp of the respective crypto asset disposal transaction.

10. The method of claim 8, further comprising:
generating a report reflecting one of: the gain associated with the matched crypto asset disposal transactions or the loss associated with the matched crypto asset disposal transactions.

11. The method of claim 8, further comprising:
generating an electronic tax accounting form reflecting one of: the gain associated with the matched crypto asset disposal transactions or the loss associated with the matched crypto asset disposal transactions;
responsive to receiving, via a graphical user interface, an approval of the electronic tax accounting form, digitally signing the electronic tax accounting form; and
uploading the electronic tax accounting form to a server authorized to accept electronic tax form filings.

12. A system, comprising:
a memory; and
a processor, coupled to the memory, wherein the processor is configured to:
identify a plurality of crypto asset trading transaction records associated with one or more specified crypto asset trading accounts, wherein each crypto asset trading transaction record of the plurality of crypto asset trading transaction records represents one of: a crypto asset acquisition transaction with respect to a specified crypto asset or a crypto asset disposal transaction with respect to the specified crypto asset;
match one or more crypto asset disposal transactions of a plurality of crypto asset trading transactions reflected by the plurality of crypto asset trading transaction records to one or more crypto asset acquisition transactions of the plurality of crypto asset trading transactions;
identify an open crypto asset lot represented by one or more unmatched crypto asset acquisition transactions of the plurality of crypto asset trading transactions;
responsive to determining that an acquisition price of the open crypto asset lot differs from an end-of-period price of the specified crypto asset, generate a simulated disposal transaction record closing the open crypto asset lot and a simulated acquisition transaction record creating a new open crypto asset lot associated with the specified crypto asset; and
append the simulated disposal transaction record and the simulated acquisition transaction record to the plurality of crypto asset trading transaction records.

13. The system of claim 12, wherein the simulated disposal transaction record reflects a disposal price of the specified crypto asset equal to the end-of-period price.

14. The system of claim 12, wherein the simulated acquisition transaction record reflects an acquisition price of the specified crypto asset equal to the end-of-period price.

15. The system of claim 12, wherein matching the one or more crypto asset disposal transactions to the one or more crypto asset acquisition transactions further comprises:
selecting a crypto asset disposal transaction of the plurality of crypto asset disposal transactions;
selecting, among the plurality of crypto asset acquisition transactions, one or more crypto asset acquisition transactions having a total amount equal to the amount of the selected crypto asset disposal transaction.

16. A non-transitory computer-readable storage medium comprising executable instructions that, when executed by a computing system, cause the computing system to:
identify a plurality of crypto asset trading transaction records associated with one or more specified crypto asset trading accounts, wherein each crypto asset trading transaction record of the plurality of crypto asset trading transaction records represents one of: a crypto asset acquisition transaction with respect to a specified crypto asset or a crypto asset disposal transaction with respect to the specified crypto asset;
match one or more crypto asset disposal transactions of a plurality of crypto asset trading transactions reflected by the plurality of crypto asset trading transaction records to one or more crypto asset acquisition transactions of the plurality of crypto asset trading transactions;
identify an open crypto asset lot represented by one or more unmatched crypto asset acquisition transactions of the plurality of crypto asset trading transactions;
responsive to determining that an acquisition price of the open crypto asset lot differs from an end-of-period price of the specified crypto asset, generate a simulated disposal transaction record closing the open crypto asset lot and a simulated acquisition transaction record creating a new open crypto asset lot associated with the specified crypto asset; and
append the simulated disposal transaction record and the simulated acquisition transaction record to the plurality of crypto asset trading transaction records.

17. The non-transitory computer-readable storage medium of claim 16, wherein the simulated disposal transaction record reflects a disposal price of the specified crypto asset equal to the end-of-period price.

18. The non-transitory computer-readable storage medium of claim 16, wherein the simulated acquisition transaction record reflects an acquisition price of the specified crypto asset equal to the end-of-period price.

19. The non-transitory computer-readable storage medium of claim 16, wherein the acquisition price of the open crypto asset lot exceeds the end-of-period price of the specified crypto asset, and wherein the simulated disposal transaction record and the simulated acquisition transaction record reflect impairment of the crypto asset.

20. The non-transitory computer-readable storage medium of claim 16, wherein the acquisition price of the open crypto asset lot is less than the end-of-period price of the specified crypto asset, and wherein the simulated disposal transaction record and the simulated acquisition transaction record reflect appreciation of the crypto asset.
